(19) United States
(12) Patent Application Publication
(10) Pub. No.: US 2025/0097858 A1
(43) Pub. Date: Mar. 20, 2025

(54) RADIO FREQUENCY EXPOSURE LIMIT COMPLIANCE CONSIDERING TOTAL ENERGY SPECIFICATION

(71) Applicant: QUALCOMM Incorporated, San Diego, CA (US)

(72) Inventors: Jagadish NADAKUDUTI, Bermuda Dunes, CA (US); Lin LU, San Diego, CA (US); Paul GUCKIAN, La Jolla, CA (US)

(21) Appl. No.: 18/471,134

(22) Filed: Sep. 20, 2023

(51) Int. Cl. H04W 52/36

(52) U.S. Cl. CPC H04W 52/367

(57) ABSTRACT

Certain aspects of the present disclosure provide techniques and apparatus for multi-radio frequency exposure limit compliance. An example method of wireless communication includes obtaining scaling information indicative of a relationship between a first radio frequency (RF) exposure limit and a second RF exposure limit. The method further includes transmitting a signal at a transmit power determined based at least in part on a maximum allowed transmit power for a time interval and the scaling information.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly for compliance.

### SUMMARY

Some aspects provide a method of wireless communication by a wireless device. The method includes obtaining scaling information indicative of a relationship between a first radio frequency (RF) exposure limit and a second RF exposure limit. The method further includes transmitting a signal at a transmit power determined based at least in part on a maximum allowed time-averaged transmit power for a time interval and the scaling information.

Some aspects provide an apparatus for wireless communication. The apparatus includes one or more memories collectively storing computer-executable instructions. The apparatus also includes one or more processors coupled to the one or more memories. The one or more processors are collectively configured to execute the computer-executable instructions to cause the apparatus to perform an operation. The operation includes obtaining scaling information indicative of a relationship between a first RF exposure limit and a second RF exposure limit. The operation also includes controlling transmission of a signal at a transmit power determined based at least in part on a maximum allowed time-averaged transmit power for a time interval and the scaling information.

Some aspects provide an apparatus for wireless communication. The apparatus includes means for obtaining scaling information indicative of a relationship between a first RF exposure limit and a second RF exposure limit. The apparatus further includes means for transmitting a signal at a transmit power determined based at least in part on a maximum allowed time-averaged transmit power for a time interval and the scaling information.

Some aspects provide a computer-readable medium. The computer-readable medium has instructions stored thereon, that when executed by an apparatus, cause the apparatus to perform a method. The method includes obtaining scaling information indicative of a relationship between a first RF exposure limit and a second RF exposure limit. The method further includes transmitting a signal at a transmit power determined based at least in part on a maximum allowed time-averaged transmit power for a time interval and the scaling information.

Some aspects provide a method of wireless communication by a wireless device. The method includes obtaining scaling information indicative of a relationship between a first radio frequency (RF) exposure limit and a second RF exposure limit. The method also includes transmitting a signal at a transmit power determined based at least in part on a maximum allowed time-averaged transmit power and the scaling information. The transmit power is less than or equal to the maximum allowed time-averaged transmit power scaled by a factor associated with the first RF exposure limit.

Some aspects provide an apparatus for wireless communication. The apparatus includes one or more memories collectively storing computer-executable instructions. The apparatus also includes one or more processors coupled to the one or more memories. The one or more processors are collectively configured to execute the computer-executable instructions to cause the apparatus to perform an operation. The operation includes obtaining scaling information indicative of a relationship between a first radio frequency (RF) exposure limit and a second RF exposure limit. The operation also includes transmitting a signal at a transmit power determined based at least in part on a maximum allowed time-averaged transmit power and the scaling information. The transmit power is less than or equal to the maximum allowed time-averaged transmit power scaled by a factor associated with the first RF exposure limit.

Some aspects provide an apparatus for wireless communication. The apparatus includes means for obtaining scaling information indicative of a relationship between a first radio frequency (RF) exposure limit and a second RF exposure limit. The apparatus also includes means for transmitting a signal at a transmit power determined based at least in part on a maximum allowed time-averaged transmit power and the scaling information. The transmit power is less than or equal to the maximum allowed time-averaged transmit power scaled by a factor associated with the first RF exposure limit.

Some aspects provide a computer-readable medium. The computer-readable medium has instructions stored thereon, that when executed by an apparatus, cause the apparatus to perform a method. The method includes obtaining scaling information indicative of a relationship between a first radio frequency (RF) exposure limit and a second RF exposure limit. The method also includes transmitting a signal at a transmit power determined based at least in part on a maximum allowed time-averaged transmit power and the scaling information. The transmit power is less than or equal to the maximum allowed time-averaged transmit power scaled by a factor associated with the first RF exposure limit.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human.

FIG. 2 is a block diagram conceptually illustrating a design of an example wireless communication device communicating with another device.

FIG. 3 is a graph illustrating examples of transmit powers over time in compliance with an RF exposure limit.

FIG. 4 is a diagram illustrating an example wireless device having multiple radios.

FIG. 5A is an example table depicting relationships between a time-averaged RF exposure limit and a total energy specification effectively for different peak transmit powers.

FIG. 5B is an example table depicting transmission times (durations) corresponding to certain peak power to time-averaged power ratios (PARs) associated with a time-averaged RF exposure limit and effective PARs associated with a total energy specification.

FIG. 6 is a flow diagram illustrating example operations for ensuring compliance with multiple RF exposure limits.

FIG. 7 illustrates a graph of example (normalized) transmit powers over time relative to a maximum time-averaged transmit power level (Pₗᵢₘᵢₜ).

FIG. 8A is an example table depicting scaling information independent of a backoff on the time-averaged RF exposure limit.

FIG. 8B is an example table depicting scaling information for a maximum allowed time-averaged transmit power.

FIG. 9 is a flow diagram illustrating example operations for wireless communication by a wireless device.

FIG. 10 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for complying with multiple radio frequency (RF) exposure limits (including a total energy specification) as further described herein.

In certain cases, a regulator (e.g., the Federal Communications Commission (FCC) for the United States) and/or standards body (e.g., the International Commission on Non-Ionizing Radiation Protection (ICNIRP) guidelines followed by the European Union (EU)) may specify multiple RF exposure limits. For example, the ICNIRP 2020 guidelines provide a time-averaged RF exposure limit (e.g., for an averaging interval of six minutes) and a total RF energy specification permitted in a specified duration (e.g., for integrating intervals greater than zero to less than six minutes). The total RF energy specification may target brief RF exposure (e.g., less than six minutes) by restricting the total energy transmitted (e.g., as a product of instantaneous RF exposure and transmit time) within a given RF exposure time-averaging time window. The total RF energy specification may provide the total level of RF exposure that a human can encounter in the specified duration with respect to various RF exposure scenarios (e.g., a local head/torso exposure scenario, a local limb exposure scenario, and/or a local absorbed energy density (Uab)). In some cases, the total RF energy specification may provide a total RF exposure level that is less than the time-averaged RF exposure limit for certain duration.

Aspects of the present disclosure provide apparatus and methods for complying with a time-averaged RF exposure limit and a total RF energy specification. A wireless communication device may apply a scaling factor to a time-averaging RF exposure evaluation to convert the transmit powers (e.g., past transmit powers and/or a maximum allowed time-averaged transmit power for a future time interval) to be in compliance with the time-averaged RF exposure limit and the total RF energy specification. The scaling factor may be indicative of a relationship between the time-averaged RF exposure limit and the total RF energy specification. As an example, the wireless device may adjust a normalized transmit power report by the scaling factor. The wireless device may determine a maximum allowed time-averaged transmit power for a future time interval based on a time-averaging RF exposure evaluation on the adjusted, normalized transmit power report. The wireless device may adjust the maximum allowed time-averaged transmit power by the scaling factor.

The apparatus and methods for multi-RF exposure limit compliance described herein may provide various advantages. For example, the multi-RF exposure limit compliance may improve wireless communication performance, including, for example, an increased throughput, decreased latency, and/or increased transmission range. The improved performance may be attributable to efficient transmit power allocations in compliance with a time-averaged RF exposure limit and a total RF energy specification. Additionally, in some examples, the apparatus and method for multi-RF exposure limit compliance may enable relatively efficient determination of transmit power allocations, linear calculations, operations that can be applied to legacy operations as well as time-averaging operations, etc., when multiple types of RF exposure scenarios are encountered by a wireless device.

As used herein, a radio may refer to a physical or logical transmission path associated with one or more frequency bands (carriers, channels, bandwidths, subdivisions thereof, etc.), transceivers, and/or radio access technologies (RATs) (e.g., wireless wide area network (WWAN), wireless local area network (WLAN), short-range communications (Bluetooth, Near Field Communication (NFC), etc.), non-terrestrial communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for Institute of Electrical and Electronics Engineers (IEEE) 802.11 may be treated as separate radios for each frequency band (e.g., 2.4 gigahertz (GHz), 5 GHZ, or 6 GHz). Example RF Exposure Compliance

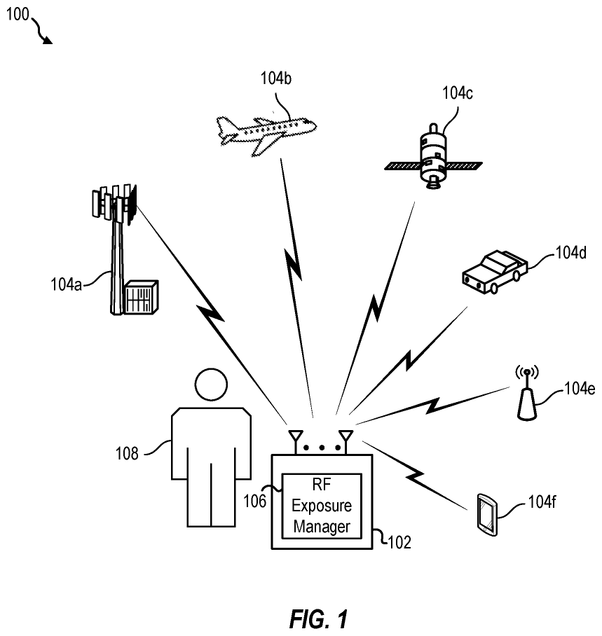

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio (NR) system (e.g., a 5G NR network), an Evolved Universal Terrestrial Radio Access (E-UTRA) system (e.g., a 4G network), a Universal Mobile Telecommunications System (UMTS) (e.g., a 2G/3G network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that ensure compliance with a time-averaged RF exposure limit and a total RF exposure specification, in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

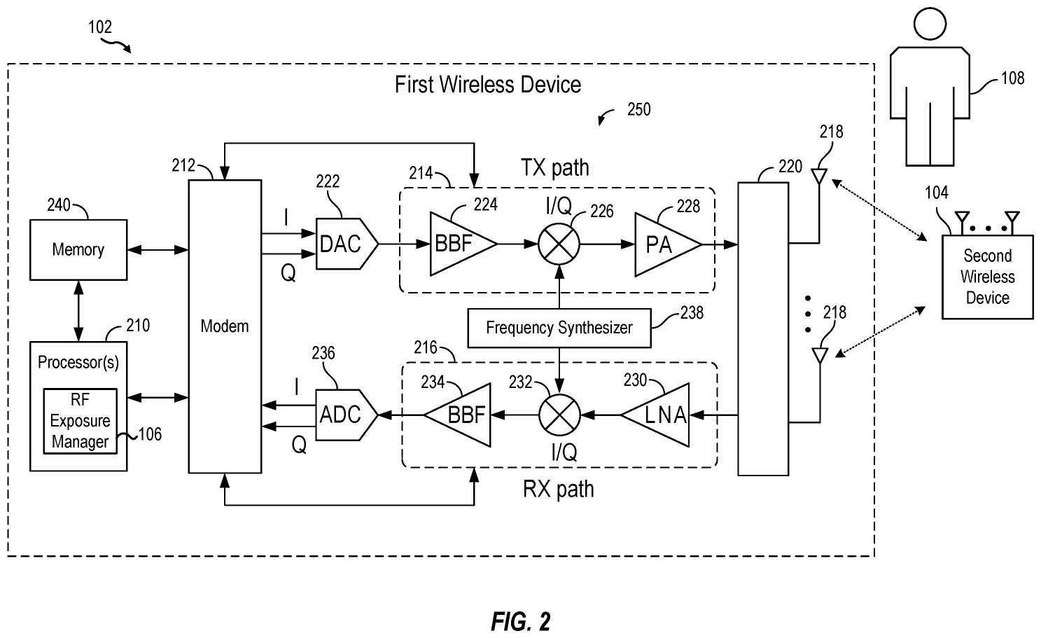

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. For example, the processor 210 may be representative of a co-processor (e.g., a microprocessor) associated with the modem 212, and the modem 212 may be representative of an ASIC including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be 100 seconds for sub-6 GHz bands, whereas the averaging time may be 2 seconds for mm Wave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

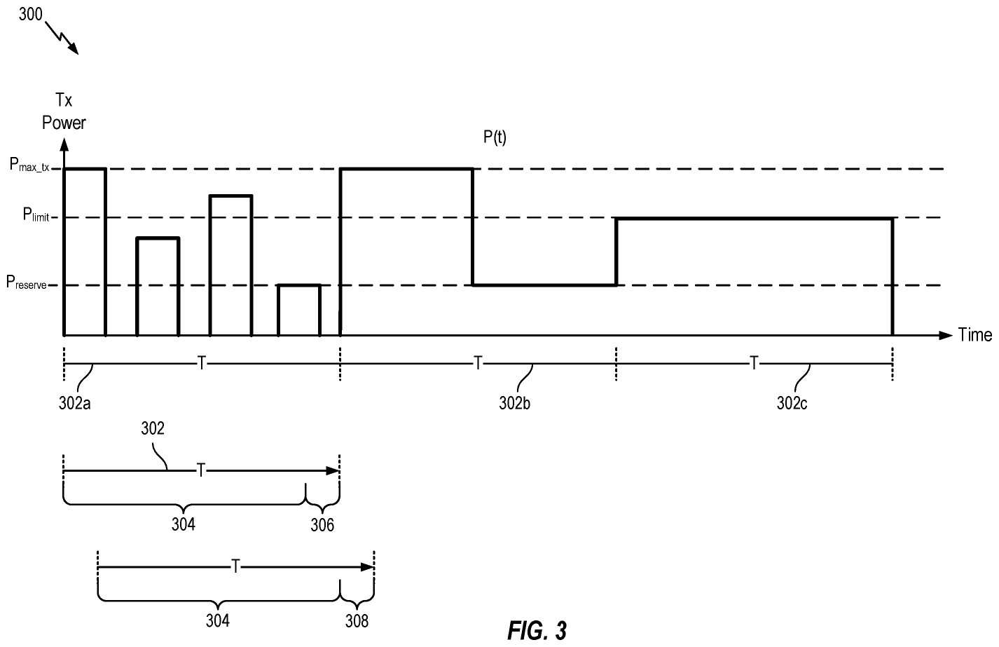

FIG. 3 is a graph 300 of a transmit power over time (P (t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target is typically selected to be less than the RF exposure limit to account for device uncertainty and/or to meet RF exposure limit in exposure scenarios that involve transmitting simultaneously with other radios within the same device that have a different RF exposure controlling mechanism.

In certain cases, an instantaneous transmit power may exceed Pₗᵢₘᵢₜ in certain transmission occasions, for example, as shown in the first time window 302a and the second time window 302b. In some cases, the wireless device may transmit at P_{max_tx}, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from P_{max_tx} to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the second time window 302b, the total area of transmit power (P (t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at P_{max_tx} for a portion of the time window with the transmitter turned off for the remainder of the time window to ensure compliance with the time-averaged RF exposure limit. Note, if Pᵣₑₛₑᵣᵥₑ is half of Pₗᵢₘᵢₜ in the second window 302b, then the area between P_{max_tx} and Pᵣₑₛₑᵣᵥₑ for the time duration of transmitting at P_{max_tx} may be equal to the area between Pₗᵢₘᵢₜ and Pᵣₑₛₑᵣᵥₑ for the time window T.

In some aspects, the wireless device may transmit at a power that is higher than Pₗᵢₘᵢₜ, but less than P_{max_tx} in the time-averaged mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior.

As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

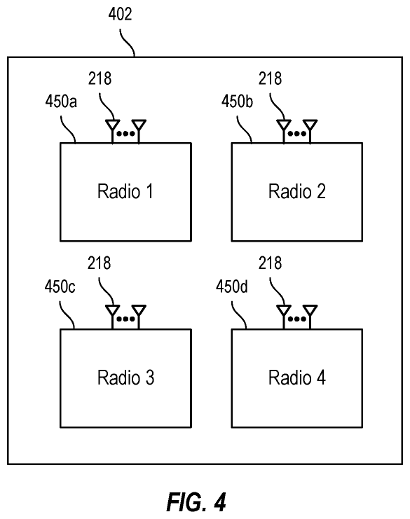

FIG. 4 is a diagram illustrating an example wireless device 402 (e.g., the first wireless device 102) having multiple radios 450a-d (e.g., the radios 250). In this example, the radios 450a-d may be associated with any of various RATs and/or frequency bands, channels, bandwidths, carriers, etc. For example, the first radio 450a may communicate via WWAN RAT(s) (e.g., E-UTRA and/or 5G NR) in sub-6 GHz frequency bands. The second radio 450b may communicate via WWAN RAT(s) (e.g., 5G NR) in mmWave frequency bands. The third radio 450c may communicate via WLAN RAT(s) in sub-6 GHz (e.g., 2.4 GHz, 5 GHZ, and/or 6 GHz) frequency bands. The fourth radio 450d may communicate via short-range communications (e.g., Bluetooth) in a 2.4 GHz frequency band. While this example shows a wireless device having four radios, a wireless device may have any number of radios for wireless communications, such as a radio per frequency band associated with WWAN and/or WLAN communications, a radio per RAT, and/or a radio capable of communicating via multiple RATs.

In certain cases, a regulator (e.g., the Federal Communications Commission (FCC) for the United States) and/or standards body (e.g., the International Commission on Non-Ionizing Radiation Protection (ICNIRP) guidelines followed by the European Union (EU)) may specify multiple RF exposure limits. For example, the ICNIRP 2020 guidelines provide a time-averaged RF exposure limit (e.g., for an averaging interval of six minutes) and a total RF energy specification permitted in a specified duration (e.g., for integrating intervals greater than zero to less than six minutes). The total RF energy specification may target brief RF exposure (e.g., less than six minutes) by restricting the total energy transmitted (e.g., as a product of instantaneous RF exposure and transmit time) within a given RF exposure time-averaging time window. The total RF energy specification may provide the total level of RF exposure that a human can encounter in the specified duration with respect to various RF exposure scenarios (e.g., a local head/torso exposure scenario, a local limb exposure scenario, and/or a local absorbed energy density (Uab)). Table 1 provides example levels for time-averaged RF exposure limits and total energy specification associated with different exposure scenarios (e.g., a head exposure scenario, a torso exposure scenario, and an extremity or limb exposure scenario).

TABLE 1
Example RF Exposure Limits

| | Time-Averaged RF | Total Energy |
|---|---|---|
| Frequency | Exposure Limit | Specification |
| ≤6 GHZ | Head/torso: | 720*[0.05 + |
| (SAR) | 10 g SAR limit of 2 W/kg | 0.95*(t/360)^{0.5}] J/kg |
| | Limb: | 1440*[0.025 + |
| | 10 g SAR limit of 4 W/kg | 0.975*(t/360)^{0.5}] J/kg |
| <30 GHz | 4 cm² PD limit of 20 W/m² | 7200*[0.05 + |
| | | 0.95*(t/360)^{0.5}] J/m² |
| >30 GHz | 1 cm² PD limit of 20 W/m² | 7200*[0.05 + |
| | | 0.95*(t/360)^{0.5}] J/m² |

where t in the various functions for the total energy specification is the transmission time (or integral interval) within a specified duration (e.g., 360 seconds). In some cases, t may be greater than 0 and less than the specified duration.

Some time-averaged RF exposure evaluations may evaluate RF exposure compliance in terms of a normalized time-averaged transmit power. As an RF exposure level may be proportional to a transmit power, a wireless device may determine a normalized time-averaged RF exposure in terms of a normalized time-averaged transmit power. The normalized time-averaged RF exposure may be less than a threshold (e.g., 1) corresponding to a maximum time-averaged power level (Pₗᵢₘᵢₜ), which may be representative of the RF exposure limit, as provided in the following expression:

$$normalized time . avg . exposure = \frac{\frac{1}{T} {\int }_{t}^{t + T} Tx . power ( t ) dt}{{P}_{limit}} \leq 1 \qquad ( 1 )$$

where T is the time-averaging time window (e.g., T=360 s), and Tx.power (t) is the transmit power over time. The total energy for a transmission may be determined according to the following expression:

$$total energy = normalized time . avg . exposure * {P}_{limit} * T \qquad ( 2 )$$

In some cases, the time-averaged RF exposure limit may not satisfy a particular total energy specification, such as the specifications provided in Table 1. In some cases, the total RF energy specification may provide a total RF exposure level that is less than the time-averaged RF exposure limit for certain durations.

### Example Radio Frequency Exposure Limit Compliance Considering Total Energy Specification

Aspects of the present disclosure provide apparatus and methods for complying with multiple RF exposure limits implemented in the same region, such as a time-averaged RF exposure limit and a total RF energy specification. A wireless communication device may apply a scaling factor to a time-averaging RF exposure evaluation to convert the transmit powers (e.g., past transmit powers and/or a maximum allowed time-averaged transmit power for a future time interval, such as the time interval 306) to be in compliance with the time-averaged RF exposure limit and the total RF energy specification. The scaling factor may be indicative of a relationship between the time-averaged RF exposure limit and the total RF energy specification. As an example, the wireless device may adjust a normalized transmit power report by the scaling factor. The wireless device may determine a maximum allowed time-averaged transmit power (e.g., P_{max_avg}) for a future time interval based on a time-averaging RF exposure evaluation on the adjusted, normalized transmit power report. The wireless device may adjust the maximum allowed time-averaged transmit power by the scaling factor. By converting the total energy specification into a scaling factor as further described herein, the wireless device may maintain compliance with the total energy specification for any variation in transmit powers (e.g., multiple transmit power levels within a time-averaging time window, such as the time window 302).

In certain aspects, a maximum time-averaged transmit power level (e.g., Pₗᵢₘᵢₜ) may be effectively converted to a particular level that satisfies the total energy specification as described herein with respect to Table 1. If a wireless device transmits for t seconds at a transmit power higher than a maximum time-averaged transmit power level (Pₗᵢₘᵢₜ), the total energy may be determined according to Expression (2). In this expression, the normalized time-averaged RF exposure may be substituted for a peak transmit power to time-averaged power ratio (PAR, where

$$PAR ( t ) = \frac{Tx . power ( t )}{{P}_{limit}} )$$

as provided by the following:

$$total energy = PAR * {P}_{limit} * t \qquad ( 3 )$$

To satisfy the total energy specification, the wireless device may evaluate the time-averaged RF exposure with respect to the total energy specification. As an example, in the case of a head exposure scenario or a torso exposure scenario, the total energy may be expressed as follows:

$$total energy = {P}_{limit} * T * [ 0.05 + 0.95 * {( \frac{t}{360} )}^{0.5} ] = Tx . power * t = {P}_{limit} * newPAR * t \qquad ( 4 )$$

where newPAR is an effective ratio (or nominal ratio or an effective PAR) for the total energy specification and ‘Pₗᵢₘᵢₜ*T’ term reflects the regulatory exposure limit*regulatory time window=2 W/kg*360 s=720 J/kg in case of head/torso exposure as shown in Table 1. The newPAR may be a power function (e.g.,

$$[ 0.05 + 0.95 * {( \frac{t}{360} )}^{0.5} ] )$$

associated with the total energy specification. The effective ratio for the total energy specification may be determined in terms of a PAR (as PAR may be equivalent to

$$\frac{T}{t} .$$

for example, as follows:

$$newPAR = PAR * [ 0.05 + 0.95 * {( \frac{1}{PAR} )}^{0.5} ] \qquad ( 5 )$$

The PAR may be indicative of the allowed transmit power level in a time-averaged RF exposure evaluation (e.g., corresponding total RF energy=time-averaged RF exposure limit*time-averaging time window), and the effective ratio (newPAR) may be indicative of the allowed transmit power level that satisfies the total energy specification. By down-scaling a maximum allowed time-averaged transmit power provided to a radio by a factor

$$( e . g . , \frac{newPAR}{PAR} )$$

representative of the relationship between PAR and newPAR and up-scaling the transmitted power (e.g., a transmit power report) with the inverse factor,

$$e . g . , ( \frac{PAR}{newPAR} ) ,$$

the time-averaged RF exposure evaluation may satisfy the total energy specification. Note that

$$\frac{newPAR}{PAR} \leq 1. .$$

For the head/torso exposure scenarios, the scaling factor may be determined as a function of PAR, for example:

$$factor ( PAR ) = \frac{newPAR}{PAR} = [ 0.05 + 0.95 * {( 1 / max ( PAR , 1 ) )}^{0.5} ] \qquad ( 6 )$$

Note that the above scaling factor may also be applicable for PD exposure in mmW NR frequency bands.

For an extremity or limb exposure scenario in SAR frequency band, the scaling factor may be determined as follows:

$$factor ( PAR ) = [ 0.025 + 0.975 * {( 1 / max ( PAR , 1 ) )}^{0.5} ] \qquad ( 7 )$$

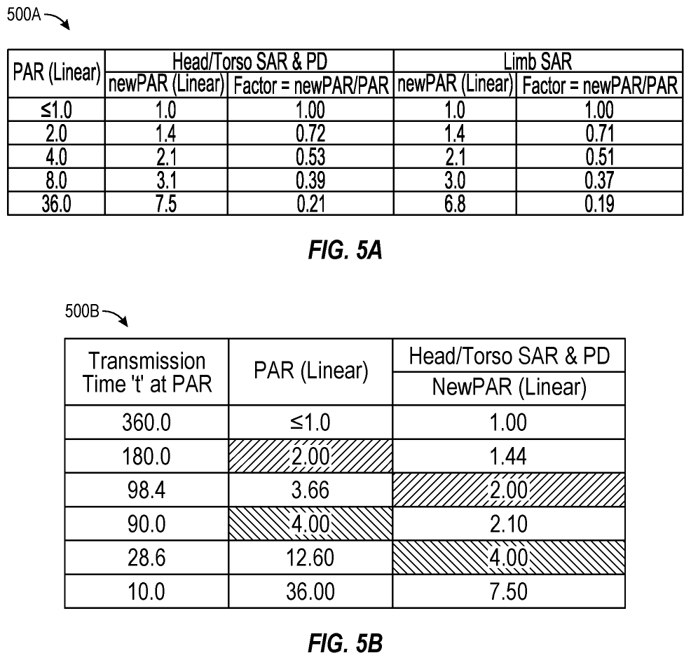

FIG. 5A is an example table 500A depicting relationships between a time-averaged RF exposure limit and a total energy specification effectively for different peak transmit powers (e.g., different PARs). In this example, the table 500A depicts the PAR values, newPAR values, and the corresponding scaling factors associated with a head/torso exposure scenario and a limb exposure scenario.

In certain aspects, the scaling factors may correspond to transmission durations that satisfy the total energy specification. As the total energy specification corresponds to a transmission duration, the wireless device may determine the transmission duration associated with the factor, and the wireless device may transmit a signal for a time interval that is less than or equal to the corresponding transmission duration. FIG. 5B is an example table 500B depicting transmission times (durations) corresponding to certain PARs associated with the time-averaged RF exposure limit and the effective PARs associated with the total energy specification. The table 500B provides the transmission times that may satisfy the total energy specification. For example, when the effective PAR is equal to four, the wireless device may be allowed to transmit at that particular transmit power (e.g., the transmit power is four times the level corresponding to the RF exposure limit) for 28.6 seconds. The scaling factor may be indicative of the transmission duration. The transmission time may be equal to the product of the scaling factor and the transmission duration corresponding to the PAR that is equal to the newPAR. For example, for a scaling factor of 0.32, the transmission duration may be equal to 28.6, e.g., the product of 90.0 and the scaling factor.

As provided in Table 1, the total energy specification may depend on a transmission duration (t). In some cases, the transmission duration may be implemented under the assumption that a wireless device transmits at a fixed transmit power (or PAR) for the entire transmission duration. For example, as can be seen in Table 500B, if a wireless device transmits at PAR of 2 (e.g., the transmit power is twice the level corresponding to the RF exposure limit), the wireless device may transmit for 98.4 seconds to satisfy total energy specification. Similarly, PAR of 4 may correspond to a transmission time of 28.6 seconds. However, if the wireless device transmits at PAR of 2 for a portion “t1” of a 360 second time window, and at PAR of 4 for another portion “t2” in the same time window, it can be challenging to determine combinations of “t1” and “t2” that are compliant with the total energy specification in real-time (answer: If t1=98.4 s*x %, then t2=28.6*(100%−x %), where x % represents the percent proportion of total energy specification consumed by transmitting at PAR of 2).

In certain aspects, the wireless device may transmit a signal for a transmission duration that is less than a maximum transmission duration based on a highest PAR supported by the wireless device. For example, suppose the wireless device is capable of outputting a signal at a transmit power corresponding to a PAR of 4, the maximum transmission duration would be 28.6 seconds as depicted in FIG. 5B.

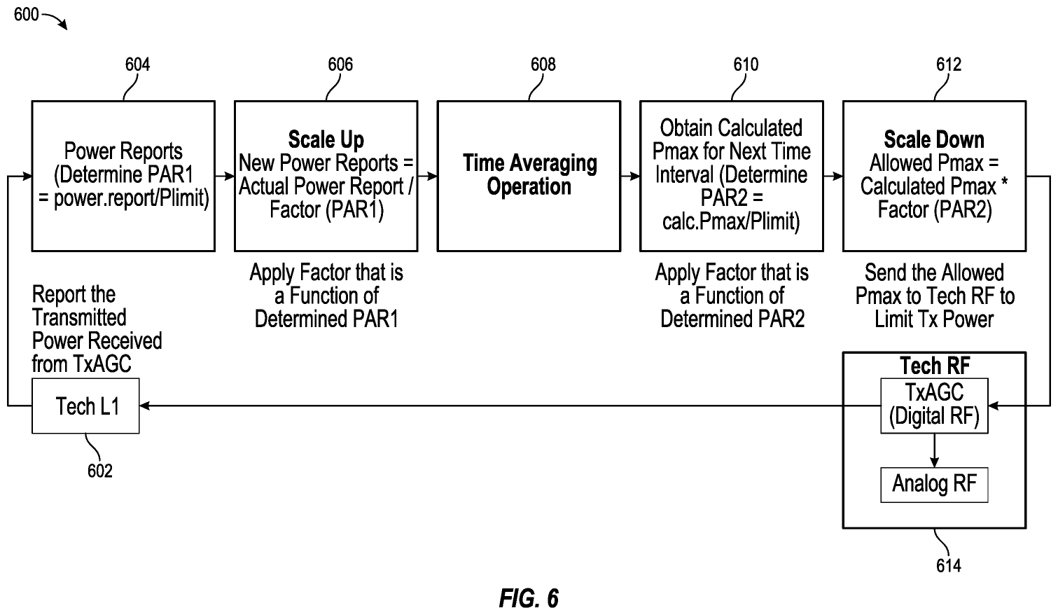

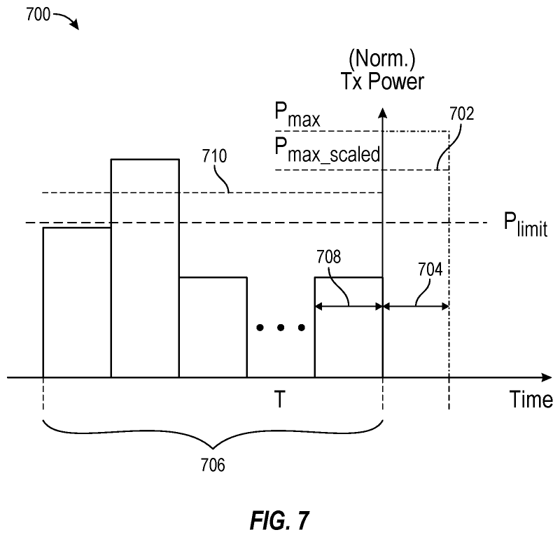

FIG. 6 is a flow diagram illustrating example operations 600 for ensuring compliance with multiple RF exposure limits. The operations 600 may be performed, for example, by a wireless device (e.g., the first wireless device 102). In certain aspects, an RF exposure manager (e.g., RF exposure manager 106) implemented by one or more processors (e.g., processor 210 and/or modem 212 of FIG. 2) of the wireless device may perform the operations 600. References to a processor or modem below may be indicative of the RF exposure manager 106 implemented within one of those components performing the described operations in some examples. In some examples, portions of the operations 600 (e.g., operation of the TxAGC, reporting of power used) may be performed by one or more radios (e.g., any of the radios 450) in communication with the noted processor, modem, or RF exposure manager. The operations 600 are described with respect to FIG. 7, which illustrates a graph 700 of example (normalized) transmit powers over time relative to a maximum time-averaged transmit power level (Pₗᵢₘᵢₜ), where reported transmit powers (e.g., past transmit powers 706 belonging to one regulatory time window) and a maximum allowed time-averaged transmit power (Pₘₐₓ) are scaled using the scaling information described herein (referred to as factor(PAR1) or factor(PAR2) in FIG. 6).

The operations 600 may optionally begin, at block 602, where the wireless device may obtain the transmit power used for a particular time interval (e.g., the second time interval 708) in a time window (T) associated with a time-averaged RF exposure limit. For example, the transmit power may be obtained from a transmit automatic gain control (TxAGC) module (or a transmit power control module) at Layer-1 (L1) of a protocol stack. For example, L1 may include the physical radio layer (PHY), which may be implemented via transceiver circuitry and/or any of the radios 450. In certain aspects, the processor 210 and/or modem 212 of the first wireless device 102 may obtain (or access) the transmit power used for the particular time interval. For example, the processor 210 and/or modem 212 may control the transmit power and track the transmit power output by the transmit path over time. A transmit power report of the past transmit powers (e.g., the past transmit powers 706) may be representative of actual transmit power(s) within an expected device uncertainty.

At block 604, the wireless device may determine a normalized power report of past transmit powers (e.g., the past transmit powers 706). The normalized power report for a particular time interval (e.g., the second time interval 708) may be a past time-averaged transmit power during a time interval (e.g., the second time interval 708) normalized using Pₗᵢₘᵢₜ. The normalized power report may be representative of the PAR, e.g., PAR1. The normalized power report may be equal to the past time-averaged transmit power(s) during the second time interval 708 divided by Pₗᵢₘᵢₜ (e.g., Normalized Power Report=time-averaged Tx Power Report/Pₗᵢₘᵢₜ), where the transmit power(s) associated with the second time interval 708 are averaged over the second time interval 708. Such normalized power reports may be computed and tracked for multiple time intervals (e.g., corresponding to the past transmit powers 706) belonging to the time-averaging time window (T). The wireless device may determine a sum of the normalized power reports associated with the past transmit powers 706.

At block 606, the wireless device may adjust the normalized power report based on scaling information, such as a scaling factor (referred to as factor(PAR1), e.g., in FIG. 6 and the description associated therewith). The wireless device may scale up the normalized power report by the scaling factor. For example, a scaled version of the normalized power report 710 may be equal to the normalized power report divided by the scaling factor. In some cases, the wireless device may refrain from using the scaling factor, or the wireless device may apply a scaling factor equal to one, for example, when the PAR is less than or equal to one (i.e., past time-averaged transmit power during a time interval is less than or equal to Pₗᵢₘᵢₜ).

At block 608, the wireless device may perform a time averaging operation based on the scaled version of the normalized power report. The wireless device may determine a normalized exposure margin allowed for the next time interval (e.g., the first time interval 704) in the time window (T) such that the time average of the scaled version of the normalized power report and the exposure margin for the next time interval satisfy the normalized scaled RF exposure design target. In certain aspects, the exposure margin may be the maximum RF exposure that the wireless device can produce and satisfy the normalized scaled RF exposure design target. The normalized exposure margin may be the percentage of exposure remaining with respect to the normalized power report and the scaled RF exposure design target. For example, the normalized scaled RF exposure design target may be satisfied when the time average of the scaled version of the normalized power report and the exposure margin for the next time interval is less than or equal to one (e.g., the normalized scaled RF exposure design target).

At block 610, the wireless device may determine the maximum allowed time-averaged transmit power (P_{max_avg}) for the next time interval (e.g., the first time interval 704). For example, the maximum allowed time-averaged transmit power (P_{max_avg}) may be equal to the product of the normalized exposure margin and Pₗᵢₘᵢₜ. The wireless device may determine the PAR associated with the maximum allowed time-averaged transmit power (e.g., PAR2=P_{max_avg}/Pₗᵢₘᵢₜ).

At block 612, the wireless device may adjust the maximum allowed time-averaged transmit power based on the scaling information, such as a scaling factor (e.g., factor(PAR2) in FIG. 6 and the description associated therewith). The wireless device may scale down the maximum allowed time-averaged transmit power by the scaling factor. For example, a scaled version of the maximum allowed time-averaged transmit power (P_{max_avg}_scaled) may be equal to a product of the maximum allowed time-averaged transmit power and the scaling factor. In some cases, the wireless device may refrain from using the scaling factor, or the wireless device may apply a scaling factor equal to one, for example, when PAR2 is less than or equal to one (e.g., the maximum allowed time-averaged transmit power (P_{max_avg}) for the next time interval is less than or equal to Pₗᵢₘᵢₜ). Referring to FIG. 7, the wireless device may use the scaled version of the maximum allowed time-averaged transmit power 702 as the maximum allowed time-averaged transmit power for the first time interval 704.

At block 614, the wireless device may provide the scaled version of the maximum allowed time-averaged transmit power 702 to transceiver circuitry (e.g., any of the radios 450). For example, the TxAGC module may obtain the scaled version of the maximum allowed time-averaged transmit power 702 as digital RF information (e.g., a particular gain index associated with an output power of the transmit path 214), and the TxAGC module may control the gains applied to circuitry (e.g., adjusting the gain at the BBF, mixer, PA, etc.) in the transmit path to output a signal (e.g., an analog RF signal) at the transmit power associated with the digital RF information. The TxAGC module may set the transmit power to a particular level, which may depend on any of various transmit power controls, such as the (scaled) maximum allowed time-averaged transmit power for RF exposure compliance, RF interference controls (e.g., via base station controls in a closed-loop power control communication), receiver saturation controls, RF emissions controls (e.g., PCMAX), thermal controls, etc. That is, the TxAGC module may set the transmit power to a particular level that is different from the (scaled) maximum allowed time-averaged transmit power obtained by the TxAGC module (e.g., at block 614), based on other criteria, such as RF interference controls, receiver saturation controls, RF emission controls, thermal controls, and variations in data required or allowed to be transmitted by the radio, as illustrative, non-limiting examples. In one illustrative example, if the wireless device is the source of interference to one or more other devices (e.g., the wireless device may determine it is the source of interference from an indication received from a base station), then the wireless device (via the TxAGC module) may set the transmit power to a level that is less than or equal to the (scaled) maximum allowed time-averaged transmit power level obtained by the TxAGC module in order to mitigate the interference to the other devices. In such an example, the transmit power level set by the TxAGC may be based on power control messages received by a base station. In another illustrative example, if an ambient temperature of the wireless device is above a threshold (or within a threshold range), then the wireless device (via the TxAGC module) may set the transmit power to a level that is less than or equal to the (scaled) maximum allowed time-averaged transmit power level obtained by the TxAGC module to avoid damaging the radio and/or other components of the wireless device. In such an example, the transmit power level set by the TxAGC may be based on thermal controls configured for the wireless device. This power level set by the TxAGC and/or a power used over a time interval may be reported back to a central algorithm (e.g., at 602), such as may be running on the RF exposure manager 106, from a respective radio including the TxAGC.

In certain aspects, the wireless device may repeat the operations 600 in accordance with a periodic interval (e.g., 500 milliseconds), for example, as described herein with respect to FIG. 3. As an example, the wireless device may receive the transmit power report for a previous transmission interval and determine the maximum allowed time-averaged transmit power for a future time interval (e.g., the time interval 306). As the time-averaging RF exposure evaluation continues to move with the rolling time window (e.g., the time window 302), the wireless device may receive the transmit power report associated with the last time interval 306 and determine the maximum allowed time-averaged transmit power for the next future time interval (e.g., the time interval 308) as described herein.

In the case of multi-transmission scenarios (e.g., multiple transmissions via multiple radios in the same time interval, such as the time interval 306, 704), the RF exposure evaluation may combine the transmit power reports (e.g., as a sum) of the multiple transmissions (e.g., via radios) and determine a maximum allowed time-averaged transmit power for each of the active radios (i.e., by distributing the normalized allowed exposure margin among the radios and multiplying it by Pₗᵢₘᵢₜ of each active radio) in the next transmission time interval (e.g., the time interval 306, 308, 704). For a multi-transmission scenario, each of the transmissions in a time interval associated with a time-averaged RF exposure limit may be associated with a particular radio among multiple radios. For example, the PARs associated with multiple radios may be summed to determine a total PAR according to the following expression:

$${PAR}_{total} = {\sum }_{i}^{N} {PAR}_{i} \qquad ( 8 )$$

where PARᵢ is the PAR associated with the i^{th} radio among N active radios and is given by P_{max_i}/P_{limit_i}. An active radio may include a radio that transmitted in a time interval (for a past transmission analysis) or is expected (e.g., via scheduling or a transmission buffer or queue has information for a transmission) to transmit in a future time interval (for a future transmission analysis).

In certain aspects, the time-averaging RF exposure evaluation described herein may apply a PARₜₒₜₐₗ where a value for PAR has been described. For example, at block 604, the wireless device may determine PAR; for each of the radios (e.g., the first radio 450a and the third radio 450c) reporting a normalized transmit power report, i.e., past time-averaged transmit power report averaged over the second time interval 708 divided by Pₗᵢₘᵢₜ (e.g., Normalized Power Report=time-averaged Tx Power Report/Pₗᵢₘᵢₜ). The wireless device may determine a total value for the PARs (PAR1 total), for example, according to Expression (8). At block 606, the wireless device may adjust the normalized transmit power reports associated with the radios based on the scaling factor corresponding to PAR1 total. For example, the wireless device may adjust a combined normalized transmit power report (e.g., a sum of the normalized transmit power reports) for the radios or individually adjust each of the transmit power reports for the radios. At block 608, the wireless device may perform a time averaging operation based on the scaled version of the normalized power report(s) as described herein to determine an exposure margin for the next time interval. At block 610, the wireless device may distribute the exposure margin among the radios (which may vary) expected to transmit in the next time interval (e.g., the first radio 450a and the second radio 450b) and determine the maximum allowed time-averaged transmit power (P_{max_avg_i}) for each of the radios (expected to transmit). The wireless device may determine the PAR associated with the maximum allowed time-averaged transmit power (e.g., PAR2; =P_{max_avg_i}/P_{limit_i}) for each of the radios (expected to transmit) and a total value for the PARs (PAR2ₜₒₜₐₗ), for example, according to Expression (7). At block 612, the wireless device may adjust the maximum allowed time-averaged transmit power (P_{max_avg_i}) for each of the radios (expected to transmit) based on the scaling factor corresponding to PAR2 total to determine the scaled maximum allowed time-averaged transmit power for the future time interval.

As a wireless device may be capable of transmitting a signal at a varying range of transmit powers (e.g., ±5%), the wireless device may be configured with a reduced Pₗᵢₘᵢₜ relative to a regulatory value for Pₗᵢₘᵢₜ to compensate for such variations in the transmit powers and ensure compliance with the RF exposure limit. The varying range of transmit powers may be due to variations in operating conditions, manufacturing conditions, etc. As an example, the reduced Pₗᵢₘᵢₜ may be expressed as:

$${P}_{limit \_ reduced} ( dBm ) = {P}_{limit \_ reg} ( dBm ) - X ( dB ) \qquad ( 9 )$$

where P_{limit_reg} may represent the Pₗᵢₘᵢₜ corresponding to a regulatory value for the RF exposure limit, and X may represent an adjustment factor (in decibels) used to reduce the regulatory value. This particular reduced Pₗᵢₘᵢₜ may represent the Pₗᵢₘᵢₜ corresponding to the RF exposure design target.

In some cases, the Pₗᵢₘᵢₜ may be reduced further, for example, to provide a multi-regional/national RF exposure compliance, for marketing or design decisions, etc. In such cases, the reduced Pₗᵢₘᵢₜ may be expressed as follows:

$${P}_{limit \_ reduced} ( dBm ) = {P}_{limit \_ reg} ( dBm ) - X ( dB ) - Y ( dB ) \qquad ( 10 )$$

Where Y may represent an additional adjustment factor (in decibels) used to reduce the regulatory value. As an example, X may represent a first adjustment factor to compensate for device uncertainties with respect to variations in the transmit powers that the device is capable of outputting, and Y may represent a second adjustment factor to further reduce the regulatory Pₗᵢₘᵢₜ, for example, for multi-regional/national compliance, marketing or design decisions, etc.

For example, suppose P_{limit_reduced} corresponds to 0.8 W/kg and X is equal to 1 dB (in linear units, 1.26), such that the P_{limit_reduced} plus X corresponds to 1 W/kg. In some cases, a region (e.g., a country in the EU), which implements a total energy specification, may have a higher Pₗᵢₘᵢₜ (e.g., the RF exposure limit for ICNIRP) equal to 2 W/kg, and thus, effectively a higher total energy specification relative to P_{limit_reduced}. In other words, the P_{limit_reduced} may be further reduced by Y to satisfy multi-regional compliance (e.g., FCC and ICNIRP). The difference (Delta) between the regulatory value for Pₗᵢₘᵢₜ and the RF exposure design target for Pₗᵢₘᵢₜ (e.g., P_{limit_reduced}+X) may expressed as:

$$delta = \frac{{P}_{limit \_ reg}}{{P}_{limit \_ reduced} + X} \qquad ( 11 )$$

Using values from the present example, the difference may be expressed as:

$$delta = \frac{2}{0.8 \cdot {10}^{1 db / 10}} = 2 \qquad ( 12 )$$

and in terms of decibels:

$${delta}_{dB} = 3 dB \qquad ( 13 )$$

In certain aspects, the difference between the regulatory value and the design target may be effectively removed from P_{limit_reduced}. The adjusted Pₗᵢₘᵢₜ may maintain compliance with the total energy specification, facilitating increased transmit powers for wireless communications. As an example, the PAR for a transmit power report (used at block 606, for example) may be expressed as:

$$PAR 1 = \frac{power \cdot report}{{P}_{limit \_ reduced} \cdot {10}^{{delta}_{dB} / 10}} \qquad ( 14 )$$

The PAR for the maximum allowed transmit power may be expressed as:

$$PAR 2 = \frac{{P}_{max}}{{P}_{limit \_ reduced} \cdot {10}^{{delta}_{dB} / 10}} \qquad ( 15 )$$

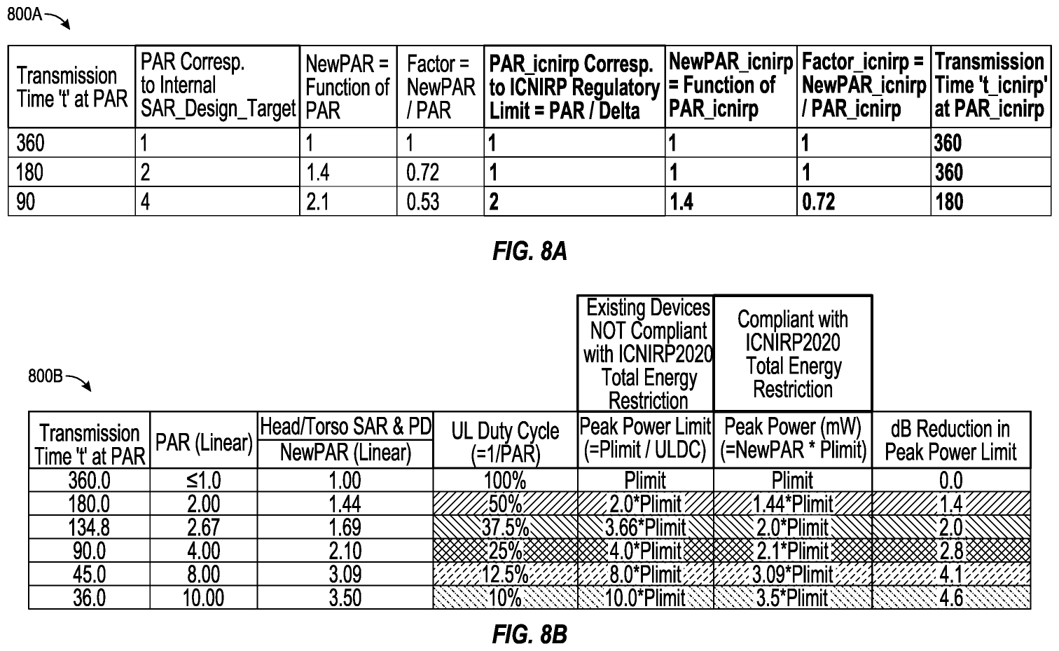

Such adjustments reduce the PAR by the difference (delta), and in turn increases the scaling factor (e.g., factor(PAR)), thereby reducing the influence of the total energy specification in the time-averaging RF exposure evaluation. For example, the PAR in the tables 500A and 500B may be replaced by a value representative of the regulatory value of the total energy specification, e.g., PAR_{reg}=min (PAR/delta, 1). The value of PAR_{reg} may result in a higher factor (i.e., factor(PAR_{reg})) as the PAR is reduced. The higher factor has an advantage as it corresponds to a longer duration for high power transmission. FIG. 8A is an example table 800A depicting scaling information independent of a backoff (e.g., delta) on the time-averaged RF exposure limit, where the PAR_icnirp values correspond to the delta being removed as described herein. Table 800A demonstrates that longer transmission durations (t_icnirp) may be achieved with this adjustment to the Pₗᵢₘᵢₜ.

In certain aspects, as the scaling factor may be a power function, the wireless device may approximate the value for the scaling factor to enhance the computational performance of the scaling factor calculation. Such an approximation may enable the wireless device to reduce the computational time and/or resources to determine the value of scaling factor for a particular PAR. As an example, in case of head/torso SAR or PD, the scaling factor and a corresponding approximation (factor(PAR)), which may be referred to as an effective scaling factor, may be expressed as:

$$factor ( PAR ) = \frac{newPAR}{PAR} = [ 0.05 + 0.95 * {( \frac{1}{max ( PAR , 1 )} )}^{0.5} ] \geq {( \frac{1}{max ( PAR , 1 )} )}^{0.5} \qquad ( 16 )$$

$$facto {r}^{′} ( PAR ) = {( \frac{1}{max ( PAR , 1 )} )}^{0.5}$$

In case of limb SAR, the scaling factor and a corresponding approximation (factor(PAR)) may be expressed as:

$$factor ( PAR ) = [ 0.025 + 0.975 * {( \frac{1}{max ( PAR , 1 )} )}^{0.5} ] \geq {( \frac{1}{max ( PAR , 1 )} )}^{0.5} \qquad ( 17 )$$

$$facto {r}^{′} ( PAR ) = {( \frac{1}{max ( PAR , 1 )} )}^{0.5}$$

In certain aspects, the effective scaling factor may be designed to cover multiple exposure scenarios. For example, the following expression for the effective scaling factor may cover limb SAR exposure, head exposure, and torso exposure:

$$facto {r}^{′} ( PAR ) = {( \frac{1}{max ( PAR , 1 )} )}^{0.5} \qquad ( 18 )$$

Referring to FIG. 6, at block 606, the wireless device may adjust the power report using the effective scaling factor, for example,

```
  new.pwr.report = power.report/factor(PAR1) = PAR1*Plimit/factor(PAR1) =
PAR1*Plimit*[max(PAR1,1)]\hat{ }(0.5) = [max(PAR1, 1)]\hat{ }(1.5) * Plimit.
  If pwr.report ≤ Plimit (e.g., PAR ≤ 1), then (in dB scale):
    new.pwr.report_dBm = pwr.report_dBm;
  else (e.g., PAR > 1),
    new.pwr.report_dBm=1.5*(pwr.report_dBm−Plimit_dBm)+ Plimit_dBm.
In certain aspects, the scaled power report may be new.pwr.report_dBm =
max{(pwr.report_dBm − Plimit_dBm); 1.5*(pwr.report_dBm − Plimit_dBm)} +
Plimit_dBm.
```

At block 612, the wireless device may adjust the maximum allowed time-averaged transmit power using the effective scaling factor, for example,

```
  allowed.Pmax.avg = calc.Pmax*factor(PAR) = PAR2*Plimit*factor(PAR) =
PAR2*Plimit/[max(PAR2,1)]\hat{ }(0.5) = [max(PAR2, 1)]\hat{ }(0.5) * Plimit.
  If calc.Pmax ≤ Plimit (e.g., PAR ≤ 1), then (in dB scale):
    allowed.Pmax.avg_dBm = calc.Pmax_dBm;
  else (e.g., PAR > 1), then
    allowed.Pmax.avg_dBm = 0.5* (calc.Pmax_dBm − Plimit_dBm) +
Plimit_dBm. In certain aspects, the scaled maximum allowed time-averaged transmit
power may be allowed.Pmax.avg_dBm = min{(calc.Pmax_dBm − Plimit_dBm);
0.5*(calc.Pmax_dBm − Plimit_dBm)} + Plimit_dBm;
```

In certain aspects, the effective PAR may be applied to a wireless device that uses a maximum allowed time-averaged transmit power without a time-averaging evaluation. In some cases, the wireless device may adjust the maximum allowed time-averaged transmit power based on a duty cycle. For example, the wireless device may only transmit a signal at less than or equal to Pₗᵢₘᵢₜ (or as adjusted by a duty cycle), for example, using a look-up table having various Pₗᵢₘᵢₜ values corresponding to various RF exposure scenarios and/or transmission scenarios (e.g., different frequency bands, antennas, antenna groups, beams, RATs, etc.).

Pₗᵢₘᵢₜ may be the maximum allowed transmit power that corresponds to an RF exposure limit if the wireless device transmits continuously, e.g., at a duty cycle of 100% (for example, an uplink duty cycle (ULDC)). In wireless devices that employ look-up tables, peak power limits may be configured in the memory settings based on ULDC. For example, in a Global System for Mobile Communication (GSM) 2 UL slot configuration where ULDC=2/8, the peak power limit=Pₗᵢₘᵢₜ/ULDC=4*Pₗᵢₘᵢₜ=Pₗᵢₘᵢₜ (dBm)+6 dB. Similarly, peak power limits may be configured accordingly in memory for different UL slot scenarios in case of GSM.

In order to meet the total energy specification, previous PAR scaling tables (e.g., Table 500A) may be adapted by setting ULDC=1/PAR, and lower the peak power limit in the memory settings from “Pₗᵢₘᵢₜ/ULDC=PAR*Pₗᵢₘᵢₜ” to “newPAR*Pₗᵢₘᵢₜ” as shown in an example Table 800B of FIG. 8B depicting scaling information associated with maximum allowed transmit power levels independent with time averaging. In the case of variable ULDC (for example, NR), the upper limit of ULDC (sent by a base station in certain control configurations, e.g., a radio resource control configuration) may be used to set the peak power limit in RF accordingly. Note that when transmitting at a low transmit power (e.g., below Pₗᵢₘᵢₜ) in real-time, then the reduction may not be used.

While tables are illustrated in FIGS. 5A, 5B, 8A, and 8B, such structures are not required. The information in these figures may be generated, stored, and/or accessed in any number of different ways. In some examples, data structures corresponding to the tables in FIGS. 5A, 5B, 8A, and 8B are stored in the memory 240 or one or more memories associated with the processor(s) 210.

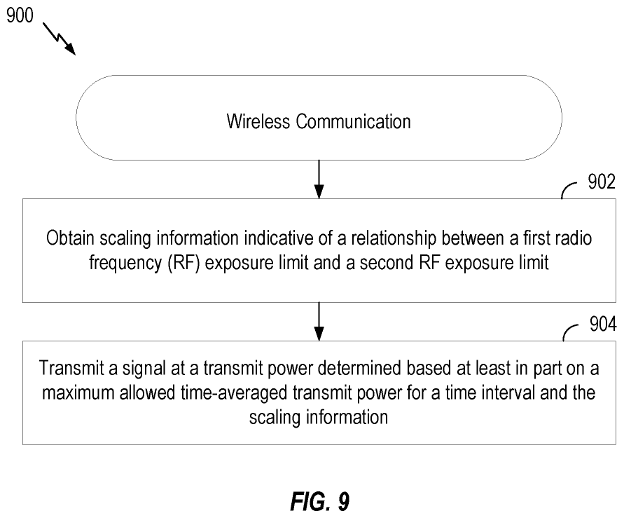

FIG. 9 is a flow diagram illustrating example operations 900 for wireless communication. The operations 900 may be performed, for example, by a wireless device (e.g., the first wireless device 102 in the wireless communication system 100). The operations 900 may be implemented as software components that are executed and run on one or more processors (e.g., the processor 210 and/or the modem 212 of FIG. 2). For example, an RF exposure manager (e.g., RF exposure manager 106) implemented via the one or more processors may perform the operations 900 or cause such operations to be performed. Further, the transmission and/or reception of signals by the wireless device in the operations 900 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 900 may optionally begin, at block 902, where the wireless device may obtain scaling information indicative of a relationship between a first radio frequency (RF) exposure limit (e.g., a total energy specification as provided in Table 1) and a second RF exposure limit (e.g., a time-averaged RF exposure limit as provided in Table 1). The first RF exposure limit may include a total RF exposure (e.g., a total energy specification) for a transmission interval (e.g., an integrating interval for determining the total energy according to the function for the total energy specification, for example, as provided in Table 1) less than a specified duration (e.g., 6 minutes, or the moving time window 302), and the second RF exposure limit may include a time-averaged RF exposure limit. In certain aspects, the first RF exposure limit and the second RF exposure may be applicable (e.g., used) in the same region or implemented by the same regulatory body (e.g., the FCC or a similar government agency in Germany, Canada, Italy, etc.) or standards body (e.g., ICNIRP). The first RF exposure limit and the second RF exposure may be associated with the same region. As an example, memory may store the scaling information, and the wireless device may obtain (or access) the scaling information via the memory, such as the memory 240.

At block 904, the wireless device may transmit a signal at a transmit power determined based at least in part on a maximum allowed time-averaged transmit power for a time interval (e.g., the time interval 306, 308, 704 associated with time-averaging) and the scaling information. For example, the wireless device may transmit the signal to another wireless communication device (e.g., any of the second wireless devices 104 depicted in FIG. 1). The signal may indicate (or carry or represent) any of various information, such as data and/or control information. In some cases, the signal may indicate (or carry or represent) one or more packets or data blocks.

In certain aspects, the scaling information may include a scaling factor, for example, as described herein with respect to Expressions (6), (7), and/or (18). For example, the scaling information may include a factor corresponding to a first ratio (e.g., the effective PAR or newPAR) associated with the first RF exposure limit and a second ratio (e.g., the PAR) associated with the second RF exposure limit. The factor may be a ratio of the first ratio to the second ratio, for example, according to Expression (6) or the like (for other exposure scenarios). The second ratio may be a quotient of a peak transmit power (e.g., a transmit power report or a maximum allowed time-averaged transmit power) to a maximum time-averaged transmit power level (e.g., Pₗᵢₘᵢₜ). In certain aspects, the first ratio may depend on the second ratio, for example, as a function of the second ratio, according to Expression (5).

In certain aspects, the wireless device may determine the transmit power via a time-averaging RF exposure evaluation using a conversion of the past transmit power (e.g., the transmit power report) and the maximum allowed time-averaged transmit power (e.g., P_{max_avg}) as described herein with respect to FIG. 6. In some cases, the wireless device may scale the maximum time-averaged transmit power level (Pₗᵢₘᵢₜ) based on the scaling factor. The wireless device may adjust a normalized power report and the maximum allowed time-averaged transmit power in a time window (e.g., the time window 302) associated with the second RF exposure limit based on the scaling information, for example, as described herein with respect to blocks 606 and 612. The wireless device may determine the transmit power based at least in part on the adjusted normalized power report and the adjusted maximum allowed time-averaged transmit power. To adjust the normalized power report and the maximum allowed time-averaged transmit power, the wireless device may scale the normalized power report by a first factor (e.g., factor(PAR1)) of the scaling information, where the first factor may correspond to a first ratio (e.g., PAR1) of a first transmit power (e.g., the transmit power associated with the transmit power report) to a maximum time-averaged transmit power level. The wireless device may scale the maximum allowed time-averaged transmit power by a second factor (e.g., factor(PAR2)) of the scaling information, where the second factor may correspond to a second ratio (e.g., PAR2) of a second transmit power (e.g., P_{max_avg}) to the maximum time-averaged transmit power level (Pₗᵢₘᵢₜ).

For certain aspects, the wireless device may determine the transmit power using a time-averaging RF exposure evaluation that accounts for the transmissions via multiple radios, for example, as described herein with respect to FIG. 6 and the total PAR. For example, at least one of the first ratio or the second ratio (with respect to the scaling operations) may be based on a sum of transmit powers associated with multiple transmissions.

In certain aspects, the wireless device may transmit the signal for a particular duration in compliance with the total energy specification (e.g., the first RF exposure limit). To transmit the signal, the wireless device may transmit the signal at the transmit power for a duration (e.g., less than 6 minutes) that is in compliance with the first RF exposure limit. In some cases, the duration may correspond to a highest ratio of a peak transmit power (e.g., P_{max_tx}) to a maximum time-averaged transmit power level supported by the wireless device. The peak transmit power may correspond to the maximum instantaneous transmit power (P_{max_tx}) as described herein with respect to FIG. 3.

In some cases, the scaling information may account for any backoffs or adjustment factors applied to Pₗᵢₘᵢₜ, for example, as described herein with respect to FIG. 8A. For example, the scaling information may be based on a regulatory value for the second RF exposure limit independent of a backoff applied to the second RF exposure limit.

In certain aspects, the scaling information may include a function for a scaling factor that facilitates compliance with multiple exposure scenarios (e.g., SAR, PD, head, torso, and/or limb) and/or represents an approximation for the first RF exposure limit to improve the computational performance of the time-averaging RF exposure evaluation, for example, as described herein with respect to the effective scaling factor. The scaling information may be based at least in part on an approximate function for the first RF exposure limit that is less than a regulatory function for the first RF exposure limit.

For certain aspects, the wireless device may determine the transmit power according to a maximum allowed time-averaged transmit power independent of a time-averaging RF exposure evaluation, for example, as described herein with respect to FIG. 8B. The transmit power may be less than or equal to the maximum allowed time-averaged transmit power scaled by a factor (e.g., the effective PAR or newPAR) associated with the first RF exposure limit.

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

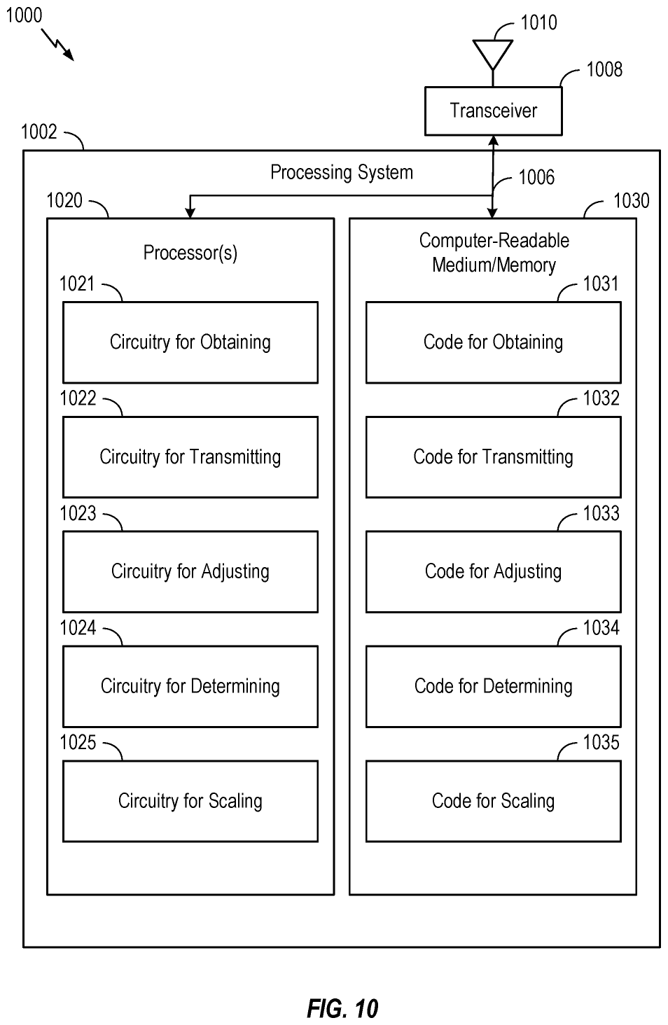

FIG. 10 depicts aspects of an example communications device 1000. In some aspects, communications device 1000 is a wireless communication device, such as the first wireless device 102 described above with respect to FIGS. 1 and 2.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of any of the processor 210 and/or the modem 212, as described with respect to FIG. 2. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the operations 900 described with respect to FIG. 9, or any aspect related to the operations described herein. Note that reference to a processor performing a function of communications device 1000 may include one or more processors performing that function of communications device 1000.

In the depicted example, computer-readable medium/memory 1030 stores code (e.g., executable instructions) for obtaining 1031, code for transmitting 1032, code for adjusting 1033, code for determining 1034, code for scaling 1035, or any combination thereof. Processing of the code 1031-1035 may cause the communications device 1000 to perform the operations 900 described with respect to FIG. 9, or any aspect related to operations described herein.

The one or more processors 1020 include circuitry configured to implement (e.g., execute) the code stored in the computer-readable medium/memory 1030, including circuitry for obtaining 1021, circuitry for transmitting 1022, circuitry for adjusting 1023, circuitry for determining 1024, circuitry for scaling 1025, or any combination thereof. Processing with circuitry 1021-1025 may cause the communications device 1000 to perform the operations 900 described with respect to FIG. 9, or any aspect related to operations described herein.

Various components of the communications device 1000 may provide means for performing the operations 900 described with respect to FIG. 9, or any aspect related to operations described herein. For example, means for transmitting, sending or outputting for transmission may include the TX path 214 and/or antenna(s) 218 of the first wireless device 102 illustrated in FIG. 2 and/or transceiver 1008 and antenna 1010 of the communications device 1000 in FIG. 10. Means for receiving or obtaining may include the RX path 216 and/or antenna(s) 218 of the first wireless device illustrated in FIG. 2 and/or transceiver 1008 and antenna 1010 of the communications device 1000 in FIG. 10. Means for obtaining, means for adjusting, means for determining, and/or means for scaling may include a processor, such as the processor 210 and/or modem 212 depicted in FIG. 2 and/or the processor(s) 1020 in FIG. 10.

### Example Aspects

Implementation examples are described in the following numbered clauses:

Clause 1: A method of wireless communication by a wireless device, comprising: obtaining scaling information indicative of a relationship between a first radio frequency (RF) exposure limit and a second RF exposure limit; and transmitting a signal at a transmit power determined based at least in part on a maximum allowed time-averaged transmit power for a time interval and the scaling information.

Clause 2: The method of Clause 1, wherein the first RF exposure limit comprises a total RF exposure for a transmission interval less than a specified duration, and wherein the second RF exposure limit comprises a time-averaged RF exposure limit.

Clause 3: The method according to any of Clauses 1-2, wherein the scaling information comprises a factor corresponding to a first ratio associated with the first RF exposure limit and a second ratio associated with the second RF exposure limit.

Clause 4: The method of Clause 3, wherein the factor is a ratio of the first ratio to the second ratio.

Clause 5: The method of Clause 3, wherein the second ratio is a quotient of a peak transmit power to a maximum time-averaged transmit power level.

Clause 6: The method of Clause 3, wherein the first ratio depends on the second ratio.

Clause 7: The method according to any of Clauses 1-6, further comprising: adjusting a normalized power report and the maximum allowed time-averaged transmit power in a time window associated with the second RF exposure limit based on the scaling information; and determining the transmit power based at least in part on the adjusted normalized power report and the adjusted maximum allowed time-averaged transmit power.

Clause 8: The method of Clause 7, wherein adjusting the normalized power report and the maximum allowed time-averaged transmit power comprises: scaling the normalized power report by a first factor of the scaling information, the first factor corresponding to a first ratio of a first transmit power to a maximum time-averaged transmit power level; and scaling the maximum allowed time-averaged transmit power by a second factor of the scaling information, the second factor corresponding to a second ratio of a second transmit power to the maximum time-averaged transmit power level.

Clause 9: The method of Clause 8, wherein at least one of the first ratio or the second ratio is based on a sum of transmit powers associated with multiple transmissions.

Clause 10: The method according to any of Clauses 1-9, wherein transmitting the signal comprises transmitting the signal at the transmit power for a duration that is in compliance with the first RF exposure limit.

Clause 11: The method of Clause 10, wherein the duration corresponds to a highest ratio of a peak transmit power to a maximum time-averaged transmit power level supported by the wireless device.

Clause 12: The method according to any of Clauses 1-11, wherein the scaling information is based on a regulatory value for the second RF exposure limit independent of a backoff applied to the second RF exposure limit.

Clause 13: The method according to any of Clauses 1-12, wherein the scaling information is based at least in part on an approximate function for the first RF exposure limit that is less than a regulatory function for the first RF exposure limit.

Clause 14: A method of wireless communication by a wireless device, comprising: obtaining scaling information indicative of a relationship between a first radio frequency (RF) exposure limit and a second RF exposure limit; and transmitting a signal at a transmit power determined based at least in part on a maximum allowed time-averaged transmit power and the scaling information, wherein the transmit power is less than or equal to the maximum allowed time-averaged transmit power scaled by a factor associated with the first RF exposure limit.

Clause 15: The method of Clause 14, wherein the scaling information comprises the factor associated with the first RF exposure limit.

Clause 16: The method according to any of Clauses 14-15, wherein the factor corresponds to a ratio associated with the first RF exposure limit.

Clause 17: The method according to any of Clauses 14-16, wherein the determination of the transmit power is independent of a time-averaging RF exposure evaluation on one or more transmit powers of the wireless device.

Clause 18: An apparatus, comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-17.

Clause 19: An apparatus for wireless communication, comprising: means for performing a method in accordance with any of Clauses 1-17.

Clause 20: A non-transitory computer-readable medium comprising computer-executable instructions that, when collectively executed by one or more processors of a processing system, cause the processing system to perform a method in accordance with any of Clauses 1-17.

Clause 21: A computer program product embodied on a computer-readable storage medium comprising code for performing a method in accordance with any of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication by a wireless device, comprising:
obtaining scaling information indicative of a relationship between a first radio frequency (RF) exposure limit and a second RF exposure limit; and
transmitting a signal at a transmit power determined based at least in part on a maximum allowed time-averaged transmit power for a time interval and the scaling information.

2. The method of claim 1, wherein the first RF exposure limit comprises a total RF exposure for a transmission interval less than a specified duration, and wherein the second RF exposure limit comprises a time-averaged RF exposure limit.

3. The method of claim 2, wherein the scaling information comprises a factor corresponding to a first ratio associated with the first RF exposure limit and a second ratio associated with the second RF exposure limit.

4. The method of claim 3, wherein the factor is a ratio of the first ratio to the second ratio.

5. The method of claim 3, wherein the second ratio is a quotient of a peak transmit power to a maximum time-averaged transmit power level.

6. The method of claim 3, wherein the first ratio depends on the second ratio.

7. The method of claim 1, further comprising:
adjusting a normalized power report and the maximum allowed time-averaged transmit power in a time window associated with the second RF exposure limit based on the scaling information; and
determining the transmit power based at least in part on the adjusted normalized power report and the adjusted maximum allowed time-averaged transmit power.

8. The method of claim 7, wherein adjusting the normalized power report and the maximum allowed time-averaged transmit power comprises:
scaling the normalized power report by a first factor of the scaling information, the first factor corresponding to a first ratio of a first transmit power to a maximum time-averaged transmit power level; and
scaling the maximum allowed time-averaged transmit power by a second factor of the scaling information, the second factor corresponding to a second ratio of a second transmit power to the maximum time-averaged transmit power level.

9. The method of claim 8, wherein at least one of the first ratio or the second ratio is based on a sum of transmit powers associated with multiple transmissions.

10. The method of claim 1, wherein transmitting the signal comprises transmitting the signal at the transmit power for a duration that is in compliance with the first RF exposure limit.

11. The method of claim 10, wherein the duration corresponds to a highest ratio of a peak transmit power to a maximum time-averaged transmit power level supported by the wireless device.

12. The method of claim 1, wherein the scaling information is based on a regulatory value for the second RF exposure limit independent of a backoff applied to the second RF exposure limit.

13. The method of claim 1, wherein the scaling information is based at least in part on an approximate function for the first RF exposure limit that is less than a regulatory function for the first RF exposure limit.

14. A method of wireless communication by a wireless device, comprising:
obtaining scaling information indicative of a relationship between a first radio frequency (RF) exposure limit and a second RF exposure limit; and
transmitting a signal at a transmit power determined based at least in part on a maximum allowed time-averaged transmit power and the scaling information, wherein the transmit power is less than or equal to the maximum allowed time-averaged transmit power scaled by a factor associated with the first RF exposure limit.

15. The method of claim 14, wherein the scaling information comprises the factor associated with the first RF exposure limit.

16. The method of claim 15, wherein the factor corresponds to a ratio associated with the first RF exposure limit.

17. The method of claim 14, wherein the determination of the transmit power is independent of a time-averaging RF exposure evaluation on one or more transmit powers of the wireless device.

18. An apparatus for wireless communication, comprising:
one or more memories collectively storing computer-executable instructions; and
one or more processors coupled to the one or more memories, the one or more processors being collectively configured to execute the computer-executable instructions to cause the apparatus to perform an operation comprising:
obtaining scaling information indicative of a relationship between a first radio frequency (RF) exposure limit and a second RF exposure limit, and
controlling transmission of a signal at a transmit power determined based at least in part on a maximum allowed time-averaged transmit power for a time interval and the scaling information.

19. The apparatus of claim 18, wherein the first RF exposure limit comprises a total RF exposure for a transmission interval less than a specified duration, and wherein the second RF exposure limit comprises a time-averaged RF exposure limit.

20. The apparatus of claim 19, wherein the scaling information comprises a factor corresponding to a first ratio associated with the first RF exposure limit and a second ratio associated with the second RF exposure limit.

21. The apparatus of claim 20, wherein the factor is a ratio of the first ratio to the second ratio.

22. The apparatus of claim 20, wherein the second ratio is a quotient of a peak transmit power to a maximum time-averaged transmit power level.

23. The apparatus of claim 20, wherein the first ratio depends on the second ratio.

24. The apparatus of claim 18, the operation further comprising:
adjusting a normalized power report and the maximum allowed time-averaged transmit power in a time window associated with the second RF exposure limit based on the scaling information; and
determining the transmit power based at least in part on the adjusted normalized power report and the adjusted maximum allowed time-averaged transmit power.

25. The apparatus of claim 24, wherein adjusting the normalized power report and the maximum allowed time-averaged transmit power comprises:
scaling the normalized power report by a first factor of the scaling information, the first factor corresponding to a first ratio of a first transmit power to a maximum time-averaged transmit power level; and
scaling the maximum allowed time-averaged transmit power by a second factor of the scaling information, the second factor corresponding to a second ratio of a second transmit power to the maximum time-averaged transmit power level.

26. The apparatus of claim 25, wherein at least one of the first ratio or the second ratio is based on a sum of transmit powers associated with multiple transmissions.

27. The apparatus of claim 18, wherein transmitting the signal comprises transmitting the signal at the transmit power for a duration that is in compliance with the first RF exposure limit.

28. The apparatus of claim 27, wherein the duration corresponds to a highest ratio of a peak transmit power to a maximum time-averaged transmit power level supported by the apparatus.

29. The apparatus of claim 18, wherein the scaling information is based on a regulatory value for the second RF exposure limit independent of a backoff applied to the second RF exposure limit.

30. The apparatus of claim 18, wherein the scaling information is based at least in part on an approximate function for the first RF exposure limit that is less than a regulatory function for the first RF exposure limit.
